(19) United States
(12) Patent Application Publication
(10) Pub. No.: US 2023/0234817 A1
(43) Pub. Date: Jul. 27, 2023

(54) STRAP HOIST ASSEMBLY

(71) Applicant: MILWAUKEE ELECTRIC TOOL CORPORATION, Brookfield, WI (US)

(72) Inventors: Nolan J. Henton, Milwaukee, WI (US); Justin Miller, Richfield, WI (US)

(21) Appl. No.: 18/159,153

(22) Filed: Jan. 25, 2023

Related U.S. Application Data
(60) Provisional application No. 63/321,283, filed on Mar. 18, 2022.
(60) Provisional application No. 63/307,724, filed on Feb. 8, 2022.
(60) Provisional application No. 63/302,651, filed on Jan. 25, 2022.

(51) Int. Cl. B66D 3/12

(52) U.S. Cl. CPC B66D 3/12

(57) ABSTRACT

A strap hoist assembly comprises a strap hoist including a frame and a reel for reeling strap, and a drive assembly removably coupled to the strap hoist. The drive assembly includes a power unit and an onboard battery pack. The drive assembly is configured to provide an output torque to rotate the reel in a rotational direction to apply an output force to the strap. The strap hoist is configured to be powered by the drive assembly or manually operated when disconnected from the drive assembly.

### CROSS REFERENCE TO RELATED APPLICATIONS

This application claims priority to co-pending U.S. Provisional Patent Application No. 63/321,283, filed on Mar. 18, 2022, U.S. Provisional Patent Application No. 63/307,724, filed on Feb. 8, 2022, and U.S. Provisional Patent Application No. 63/302,651, filed on Jan. 25, 2022. The entire contents of all of the above-identified disclosures are incorporated herein by reference.

### FIELD OF THE INVENTION

The present invention relates to a power tool, and more particularly, power tools and strap hoist assemblies.

### BACKGROUND OF THE INVENTION

Strap hoists are known in the art, among other purposes, for tensioning high power electrical wires. Typically, strap hoists are operated manually by hand or only include a manual operation for tensioning high power electrical wires. Manual operation of the strap hoists is undesirable for an operator because manual operation increases the labor required to adjust the tension of high-power electrical wires. Increased manual labor can lead to adverse health issues for the operator. Therefore, there is a need in the art for a strap hoist that alleviates strain on the operator during the tensioning of high power electrical wires.

### SUMMARY OF THE INVENTION

The present invention provides, in one aspect, a strap hoist assembly comprising a strap hoist including a frame and a reel for reeling a strap, and a drive assembly removably coupled to the strap hoist. The drive assembly includes a power unit and an onboard battery pack. The drive assembly is configured to provide an output torque to rotate the reel in a rotational direction to apply an output force to the strap, and wherein the strap hoist is configured to be powered by the drive assembly or manually operated when disconnected from the drive assembly.

The present invention provides, in another aspect, a strap hoist assembly comprising a strap hoist including a frame and a reel for reeling a strap, the strap hoist having a force rating, and a drive assembly removably coupled to the strap hoist. The drive assembly is configured to provide an output torque to rotate the reel in a rotational direction to apply an output force to the strap. The strap hoist assembly includes a mechanical advantage mechanism configured to adjust the output torque applied to the reel such that the output force on the strap is equal to or less than the force rating of the strap hoist.

The present invention provides, in another aspect, a strap hoist assembly comprising a first strap hoist including a first frame and a first reel for reeling a first strap, the first strap hoist having a first force rating, a second strap hoist including a second frame and a second reel for reeling a second strap, the second strap hoist having a second force rating that is less than the first force rating, and a drive assembly removably coupled to one of the first strap hoist or the second strap hoist. The drive assembly is configured to provide an output torque to rotate the first reel or the second reel in a rotational direction to apply an output force to the first strap or the second strap, respectively, and wherein one of the first strap hoist or the second strap hoist is configured to be powered by the drive assembly or manually operated when disconnected from the drive assembly.

The present invention provides, in another aspect, a strap hoist assembly comprising a first strap hoist including a first frame and a first reel for reeling a first strap, the first strap hoist having a first force rating, a second strap hoist including a second frame and a second reel for reeling a second strap, the second strap hoist having a second force rating that is less than the first force rating, and a drive assembly removably coupled to one of the first strap hoist or the second strap hoist. The drive assembly is configured to provide an output torque to rotate the first reel or the second reel in a rotational direction to apply an output force to the first strap or the second strap, respectively. The strap hoist assembly further includes an electronic clutch configured to adjust the output torque from the drive assembly.

The present invention provides, in another aspect, a strap hoist assembly comprising a strap hoist including a frame, a reel for reeling a strap, and an external protrusion, the strap hoist having a force rating, and a drive assembly removably coupled to the strap hoist. The drive assembly is configured to provide an output torque to rotate the reel in a rotational direction to apply an output force on the strap, the drive assembly having a detent and a switch supported within the detent, wherein the external protrusion of the strap hoist is configured to align with the detent of the drive assembly to acuate the switch, and wherein actuation of the switch is configured to adjust the output torque from the drive assembly to the reel of the strap hoist so the output force on the strap is equal to or less than the force rating of the strap hoist.

The present invention provides, in another aspect, a strap hoist assembly comprising a first strap hoist including a first frame and a first reel for reeling a first strap, the first strap hoist having a first force rating, a second strap hoist including a second frame and a second reel for reeling a second strap, the second strap hoist having a second force rating that is less than the first force rating, and a drive assembly removably coupled to one of the first strap hoist or the second strap hoist. The drive assembly is configured to provide a first output torque in a first rotational direction when the first strap hoist is coupled to the drive assembly in a first orientation, the drive assembly configured to provide a second output torque in a second rotational direction when the second strap hoist is coupled to the drive assembly in a second orientation, the first orientation being different than the second orientation.

The present invention provides, in another aspect, a strap hoist assembly comprising a strap hoist including a frame and a reel for reeling a strap, a first drive assembly removably coupled to the strap hoist, the first drive assembly including a power unit and a first coupler configured to removably couple the power unit to the strap hoist, and a second drive assembly removably coupled to the strap hoist, the second drive assembly including a lever and a second coupler configured to removably couple the lever to the strap hoist. The strap hoist assembly is configured to be operated by the power unit when the first drive assembly is coupled to the strap hoist and the strap hoist assembly is configured to be manually operated in response to movement of the lever when the second drive assembly is coupled to the strap hoist.

Other features and aspects of the invention will become apparent by consideration of the following detailed description and accompanying drawings.

### BRIEF DESCRIPTION OF THE DRAWINGS

FIG. 1 illustrates a schematic view of a strap hoist assembly according to an embodiment of the invention.

FIG. 2 illustrates a perspective view of an exemplary embodiment of the strap hoist assembly of FIG. 1.

FIG. 3 is a schematic view of multiple sized reels configured to couple to a strap hoist of the strap hoist assembly of FIG. 2.

FIG. 4 illustrates a schematic view of a strap hoist assembly according to another embodiment of the invention.

FIG. 5 illustrates a mechanical advantage mechanism integrated with a strap hoist of the strap hoist assembly of FIG. 4.

FIG. 6 illustrates a schematic view of a strap hoist assembly according to another embodiment of the invention.

FIG. 7 illustrates a mechanical clutch integrated with a strap hoist of the strap hoist assembly of FIG. 6.

FIG. 8 illustrates a perspective exploded view of a strap hoist assembly according to another embodiment of the invention.

FIG. 9 illustrates a flow chart of a first method of operation of the strap hoist assembly of FIG. 8.

FIG. 10 illustrates a flow chart of a second method of operation of the strap hoist assembly of FIG. 8

FIG. 11 illustrates a perspective view of a strap hoist assembly including a first strap hoist coupled to a drive assembly according to another embodiment of the invention.

FIG. 12 illustrates a perspective view of a second strap hoist coupled to the drive assembly of FIG. 11.

FIG. 13A illustrates a schematic view of a strap hoist assembly according to another embodiment of the invention.

FIG. 13B illustrate a schematic view of a strap hoist assembly according to another embodiment of the invention.

FIG. 14 illustrates a perspective view of the strap hoist assembly of FIG. 13A.

FIG. 15A illustrates a schematic view of a strap hoist assembly according to another embodiment of the invention.

FIG. 15B illustrates a schematic view of a strap hoist assembly according to another embodiment of the invention.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

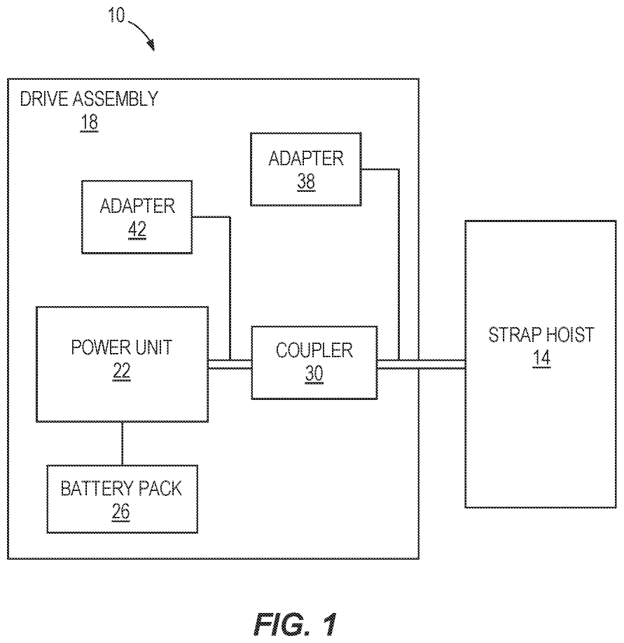

FIG. 1 illustrates a schematic view of a strap hoist assembly 10 including a strap hoist 14 and a drive assembly 18 removably coupled to the strap hoist 14. The drive assembly 18 is operably coupled to the strap hoist 14 to selectively operate the strap hoist 14. The strap hoist 14 is further manually operable when disconnected from the drive assembly 18. In other words, the strap hoist 14 may be both manually operated when disconnected from the drive assembly 18 or powered by the drive assembly 18. For example, the strap hoist assembly 10 allows an operator to tension high power electrical wires. The strap hoist assembly 10 including the strap hoist 14 powered by the drive assembly 18 alleviates strain on the operator during the tensioning of high power electrical wires.

With reference to FIG. 1, the drive assembly 18 includes a power unit 22, a battery pack 26 operably coupled to the power unit 22, and a coupler 30 that couples the power unit 22 to the strap hoist 14. In some embodiments, the power unit 22 may be a power tool (e.g., a drill, an impact drill, a right-angle drill, or a pipe threader) that is powered by the battery pack 26. In other embodiments, the power unit 22 may be an electric motor such as a brushless direct current (DC) motor. In the illustrated embodiment, the battery pack 26 is an 18-volt battery pack 26.

With continued reference to FIG. 1, the coupler 30 includes an adapter 38 that allows the drive assembly 18 to be removed from the strap hoist 14. The adapter 38 can be a quick-disconnect adapter 38. In one embodiment, the adapter 38 can be integrally formed on the coupler 30, and is positioned between the coupler 30 and the strap hoist 14. The adapter 38 engages a corresponding structure on the strap hoist 14 to secure the drive assembly 18 to the strap hoist 14. In other embodiments, the adapter 38 may be formed on the strap hoist 14. In other embodiments still, the adapter 38 can be separately formed from the coupler 30 or the strap hoist 14. Further, a second adapter 42 (FIG. 1) may be positioned between the power unit 22 and the coupler 30 that allows the coupler 30 to be removed from the power unit 22. The second adapter 42 may be integrally formed or separately formed from the strap hoist 14 or the coupler 30.

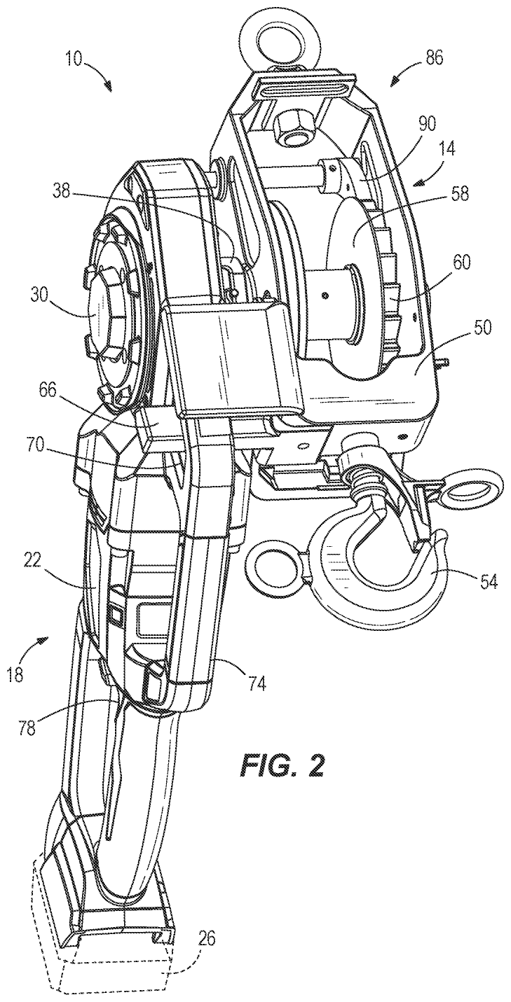

FIG. 2 illustrates the strap hoist assembly 10 according to an embodiment of the invention. In the illustrated embodiment, the power unit 22 is a handheld pipe threader. The strap hoist 14 includes a frame 50, a hook 54 attached to the frame 50, a reel 58 disposed on the frame 50 for supporting a strap wrapped about the reel 58, and a lever or handle pivotably coupled to the frame 50 for manually rotating the reel 58 when the drive assembly 18 is disconnected from the strap hoist 14. For example, the reel 58 includes a ratchet wheel 60, the frame 50 includes an engagement protrusion coupled to the ratchet wheel 60, and the lever includes a corresponding engagement structure. During manual rotation, the reel 58 is driven by pivoting the lever about a pivot axis that is coaxial with the adapter 38. When the lever is pivoted relative to the reel 58, the engagement structure of the lever engages the ratchet wheel 60 such that the lever rotates the reel 58 in a first rotational direction to tighten the strap. Similarly, as the lever is pivoted in an opposite direction relative to the reel 58, the reel 58 rotates in an opposite rotational direction to loosen the strap.

With continued reference to FIG. 2, the frame 50 includes an anti-rotation protrusion 66 that is received within a corresponding slot 70 formed in the drive assembly 18 (e.g., in a housing 74 of the power unit 22). The anti-rotation protrusion 66 restricts rotation of the strap hoist 14 relative to the drive assembly 18 when the power unit 22 is activated to provide torque to the strap hoist 14. When the drive assembly 18 is coupled to the strap hoist 14, the coupler 30 is operably coupled to the reel 58 via the adapter 38. The housing 74 of the power unit 22 includes a trigger or actuator 78 configured to be graspable and depressible by the operator of the drive assembly 18. Actuation of a trigger or actuator 78 causes the power unit 22 of the drive assembly 18 to rotate the coupler 30 and the reel 58 of the strap hoist 14 in a first rotational direction, which tightens the strap. The first rotational direction of an output shaft (not shown) of the coupler 30 may be changed to a second rotational direction (e.g., via a switch). The switch may be disposed on the housing 74 of the power unit 22. After pressing the switch, actuation of the trigger or actuator 78 causes the power unit 22 to rotate the output shaft of the coupler 30 and the reel 58 of the strap hoist 14 in the second rotational direction, which permits the effective length of the strap to be increased.

The strap hoist 14 further includes a reversing mechanism 86 (FIG. 2). The reversing mechanism 86 is operated by moving a pawl 90 out of engagement with the ratchet wheel 60 such that the reel 58 can move in the second rotational direction. In other embodiments, the power unit 22 or the strap hoist 14 may have an alternative braking mechanism to prevent the strap hoist 14 from unintentionally loosening and to restrict reverse movement of the ratchet wheel 60. In some embodiments, the braking mechanism is operated by engaging the pawl 90 with the ratchet wheel 60 to restrict rotation of the reel 58. In such embodiments, the reversing mechanism 86 may deactivate the brake mechanism prior to allowing the reel 58 to move in the second rotational direction.

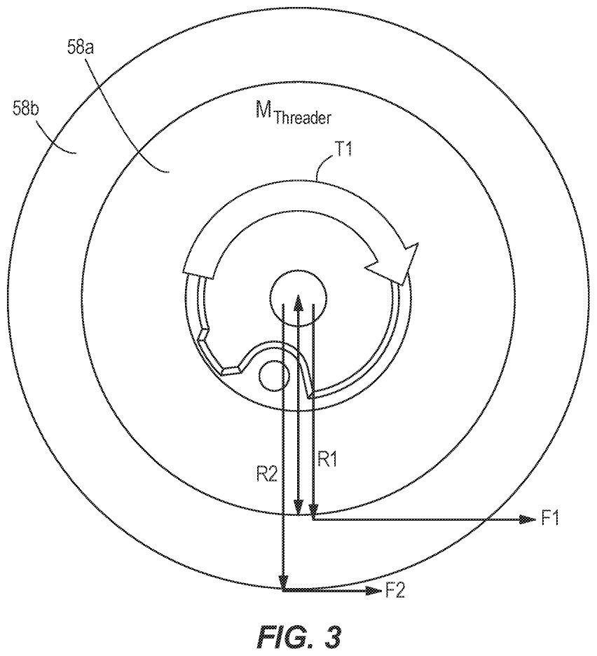

The strap hoist 14 is operable in a first, tightening configuration and a second, loosening configuration. In the tightening configuration, the hook 54 may be coupled with a first receiving surface and the strap is coupled with a second receiving surface. In the tightening configuration, the power unit 22 provides torque T1 (FIG. 3) to the reel 58 to rotate the reel 58 in the first rotational direction, which imparts a maximum output force F on the strap (thereby defining a rated tension or force) to apply tension to the strap.

FIG. 3 illustrates a reel 58a and a reel 58b configured to be attached to the strap hoist 14. The strap (not shown) is configured to wrapped or be routed around the reels 58a, 58b. The reels 58a, 58b may be designed with a maximum radius R1, R2 respectively such that, when the power unit 22 is operated at a predetermined applied torque setting (e.g., a standard or maximum torque setting), the reels 58a, 58b apply an output force F1, F2 respectively on the strap. The maximum radii R1, R2 limits the output force F1, F2 to not exceed the rated force of the strap hoist 14. The maximum output force F1, F2 is equal to the quotient of the applied torque T of the power unit 22 and the radius R1, R2 of the reels 58a, 58b respectively. In other words, increasing the radii of the reels 58a, 58b will decrease the output force F1, F2 available to apply tension to the strap.

In other embodiments, the strap hoist assembly 10 further includes a second strap hoist (not shown). The second strap hoist can be similar to the strap hoist 14 described above, with the following differences explained below. The strap hoist 14 includes the first reel 58a with the first radius R1. The second strap hoist includes the second reel 58b with the second radius R2. The second radius R2 is greater than the first radius R1.

The strap hoist 14 and the second strap hoist are removably coupled to the power unit 22. The strap hoist 14 with the first reel 58a includes a first rated force (e.g., 2 tons), and the second strap hoist with the second reel 58b includes a second rated force (e.g., 1.5 ton) that is less than the first rated force. For example, the radius R1 of the reel 58a can be designed to ensure the force output F1 is equal to or less than the rated force of the strap hoist 14. For further example, the radius R2 of the reel 58b can be designed to ensure the force output F2 is equal to or less than the rated force of the second strap hoist. In other words, the power unit 22 can stall or shut down to prevent the power unit 22 from developing an excessive torque that exceeds the rated force of the strap hoist 14 or the second strap hoist.

In other embodiments, the strap hoist assembly 10 further includes a third strap hoist (not shown). The third strap hoist can be similar to the strap hoist 14 described above, with the following differences explained below. The third strap hoist includes a third reel with a radius R3 that is less than the radius R1 of the first reel 58a (e.g., for strap hoists with rated forces greater than the first rated force), or a radius R3 that is greater than the second radius R2 (e.g., for strap hoists with rated forces less than the second rated force). In other embodiments still, the strap hoist 14, the second strap hoist, and the third strap hoist may include other force ratings and result in utilization of other reels with other radii to accommodate the force rating the selected strap hoist. As such, a single drive assembly 18 can be utilized for multiple strap hoists with different force ratings.

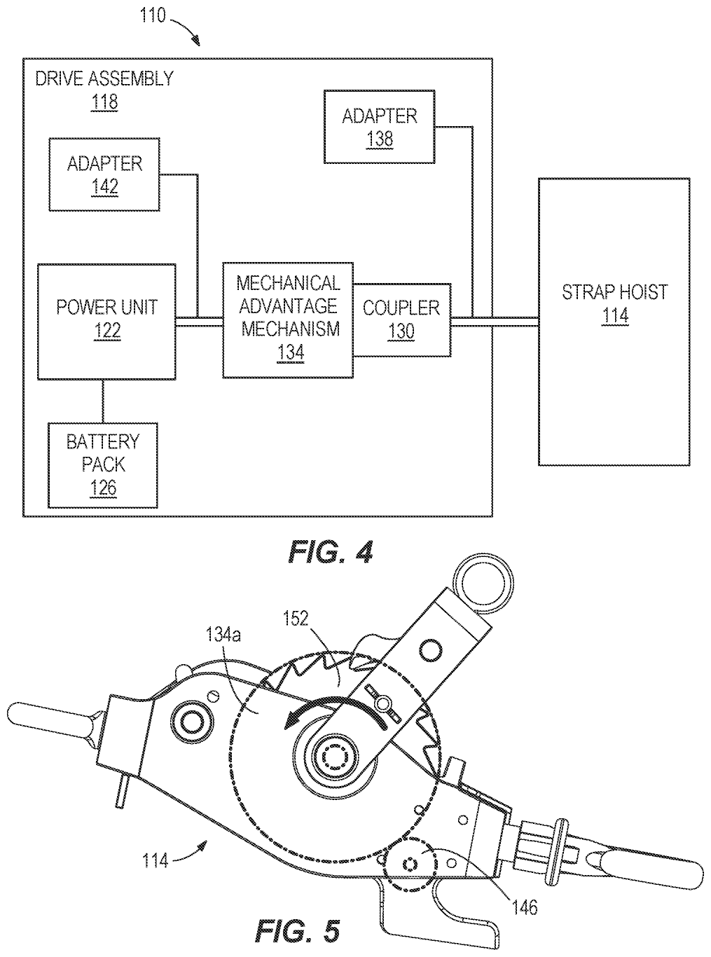

FIGS. 4 and 5 illustrate a strap hoist assembly 110 according to another embodiment of the invention. The strap hoist assembly 110 is similar to the strap hoist assembly 10 described above, with like parts having the same reference number plus “100”, and the follow differences explained below. The strap hoist assembly 110 includes a strap hoist 114 and a drive assembly 118 removably coupled to the strap hoist 114. The drive assembly 118 is operably coupled to the strap hoist 114 to selectively operate the strap hoist 114. The strap hoist 114 is further manually operable when disconnected from the drive assembly 118. In other words, the strap hoist 114 is both manually operated when disconnected from the drive assembly 118 or powered by the drive assembly 118. The strap hoist assembly 110 including the strap hoist 14 powered by the drive assembly 118 alleviates strain on the operator during the tensioning of high power electrical wires.

With reference to FIG. 4, the drive assembly 118 includes a power unit 122, a battery pack 126 operably coupled to the power unit 122, and a coupler 130 that couples the power unit 122 to the strap hoist 114. In some embodiments, the power unit 122 can be a power tool (e.g., drill, an impact drill, a right-angle drill, or pipe threader) that is powered by the battery pack 126. In other embodiments, the power unit 122 can include an electric motor (e.g., a brushless DC electric motor) that is powered by the battery pack 126, such as an 18-volt battery pack 126.

With reference to FIGS. 4 and 5, the strap hoist assembly 110 further includes a mechanical advantage mechanism 134. The mechanical advantage mechanism 134 is positioned between the power unit 122 and the strap hoist 114. In some embodiments, the mechanical advantage mechanism 134 can be integrated with the drive assembly 118 (FIG. 4). In some embodiments, the mechanical advantage mechanism 134 can be integrated with the coupler 130 of the drive assembly 118. In other embodiments, the mechanical advantage mechanism 134 can be integrated with the strap hoist 114 (FIG. 5). The mechanical advantage mechanism 134 can include one or more of a gear train, a cam, a ball screw, or a linkage system. The mechanical advantage mechanism 134 is operable to adjust the torque input to the strap hoist 114. The mechanical advantage mechanism 134 for example, can increase the torque input to the strap hoist 114, thereby not requiring the power unit 122 to provide a large torque output. In other examples, the mechanical advantage mechanism 134 can decrease the torque input to the strap hoist 114, thereby preventing the power unit 122 from providing an excessive torque output.

Referring to FIG. 4, the coupler 130 includes an adapter 138 that allows the drive assembly 118 to be removed from the strap hoist 114. The adapter 138 engages a corresponding structure on the strap hoist 114 to secure the drive assembly 118 to the strap hoist 114. Further, a second adapter 142 may be positioned between the power unit 122 and the coupler 130 to allow the coupler 130 to be removed from the power unit 122.

FIG. 5 illustrates a mechanical advantage mechanism 134a according to an alternative embodiment of the invention. The mechanical advantage mechanism 134a can be similar to the mechanical advantage mechanism 134 described above, with like parts having the same reference numeral plus the letter “a”, and the following differences explained below. The mechanical advantage mechanism 134a is a gear train including a first gear 146 and a second gear 152. The mechanical advantage mechanism 134a is integrated with the strap hoist 114. Specifically, the first gear 146 and the second gear 152 are integrated with the strap hoist 114. During operation, the drive assembly 118 is coupled to the first gear 146 to drive the second gear 152 thereby driving a reel (not shown) of the strap hoist 114.

The first gear 146 includes a plurality of first teeth and the second gear 152 includes a plurality of second teeth. The first teeth of the first gear 146 intermesh with the second teeth of the second gear 152. When assembled, the first teeth of the first gear 146 and the second teeth of the second gear 152 are intermesh together such that the rotation of the first gear 146 results in rotation of the second gear 152 thereby resulting in rotation of the reel (not shown) of the strap hoist 114. The mechanical advantage mechanism 134a is operable to increase the torque input to the strap hoist 114, thereby not requiring the power unit 122 itself to provide a large torque output.

The strap hoist assembly 110 can further include a second strap hoist (not shown). The strap hoist 114 can be a first strap hoist 114 with a first rated force (e.g., 1.5 tons) that utilizes the mechanical advantage mechanism 134. The second strap hoist includes a second rated force (e.g., 2 tons) greater than the first rated force that utilizes the mechanical advantage mechanism 134a. The drive assembly 118 is configured to be coupled to the first strap hoist 114 including the mechanical advantage mechanism 134, and the second strap hoist including the mechanical advantage mechanism 134a. The mechanical advantage mechanism 134, 134a allows a single drive assembly 118 to be used with multiple strap hoists with varying force ratings.

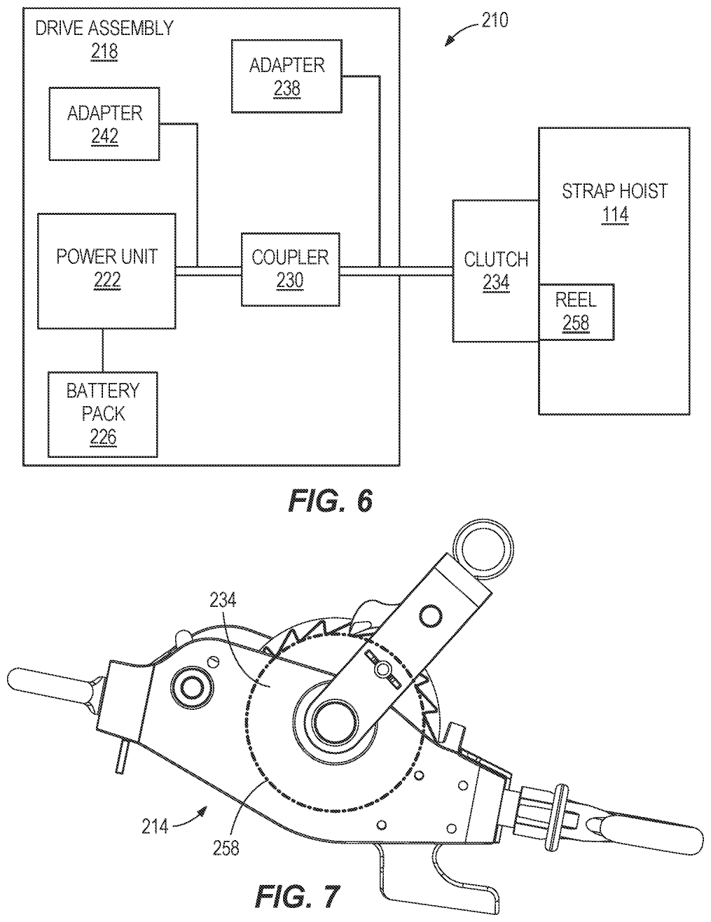

FIGS. 6 and 7 illustrate a strap hoist assembly 210 according to another embodiment of the invention. The strap hoist assembly 210 is similar to the strap hoist assembly 10 described above, with like parts having the same reference number plus “200”, and the following differences explained below. The strap hoist assembly 210 includes a strap hoist 214 and a drive assembly 218 removably coupled to the strap hoist 214. The drive assembly 218 is operably coupled to the strap hoist 214 to selectively operate the strap hoist 214. The strap hoist 214 is further manually operable when disconnected from the drive assembly 218. In other words, the strap hoist 214 is both manually operated when disconnected from the drive assembly 218 or powered by the drive assembly 218. The strap hoist assembly 210 including the strap hoist 214 powered by the drive assembly 218 alleviates strain on the operator during the tensioning of high power electrical wires.

The drive assembly 218 includes a power unit 222, a battery pack 226 operably coupled to the power unit 222, and a coupler 230 that couples the power unit 222 to the strap hoist 214. In some embodiments, the power unit 22 may be a power tool (e.g., a drill, an impact drill, a right-angle drill, or a pipe threader) that is powered by the battery pack 226, such as an 18-volt battery pack 226. In other embodiments, the power unit 22 may be an electric motor such as a brushless direct current (DC) motor.

Referring to FIG. 6, the coupler 230 includes an adapter 238 that allows the drive assembly 218 to be removed from the strap hoist 214. The adapter 238 engages a corresponding structure on the strap hoist 214 to secure the drive assembly 218 to the strap hoist 214. Further, a second adapter 242 may be positioned between the power unit 222 and the coupler 230 to allow the coupler 230 to be removed from the power unit 222.

With reference to FIGS. 6 and 7, the strap hoist assembly 210 further includes a mechanical clutch 234 integrated with the strap hoist 214. As schematically shown in FIG. 6, the mechanical clutch 234 is positioned between a reel 258 of the strap hoist 214 and the coupler 230. During operation, the mechanical clutch 234 is configured to limit the torque transferred from the power unit 222 to the reel 258. In an engaged state, the mechanical clutch 234 transfers a maximum amount of torque developed by the power unit 222 to the reel 258. In a partially or fully disengaged state, the mechanical clutch 234 transfers less than the maximum amount of torque developed by the power unit 222 to the reel 258.

The state of the mechanical clutch 234 is selected such that the torque provided by the power unit 222 will not cause the output force of the strap hoist 214 to exceed the rated force of the strap hoist 214. As such, the mechanical clutch 234 allows a single drive assembly 218 to be used with multiple strap hoists of varying maximum rated forces. In other words, the power unit 222 of the drive assembly 218 may provide a torque output that provides enough torque for the largest force rated strap hoist that is used with the drive assembly 218 and the mechanical clutch 234 is configured to limit the torque transferred to strap hoists with lower rated forces. For example, the strap hoist 214 with a first rated force (e.g., 2 tons) may not utilize the mechanical clutch 234. While a second strap hoist with a second rated force (e.g., 1.5 tons) that is less than the first rated force may utilize the mechanical clutch 234 to limit the torque transferred to the second strap hoist. In some embodiments, the amount of torque the mechanical clutch 234 limits to the strap hoist 214 may be selected during manufacturing.

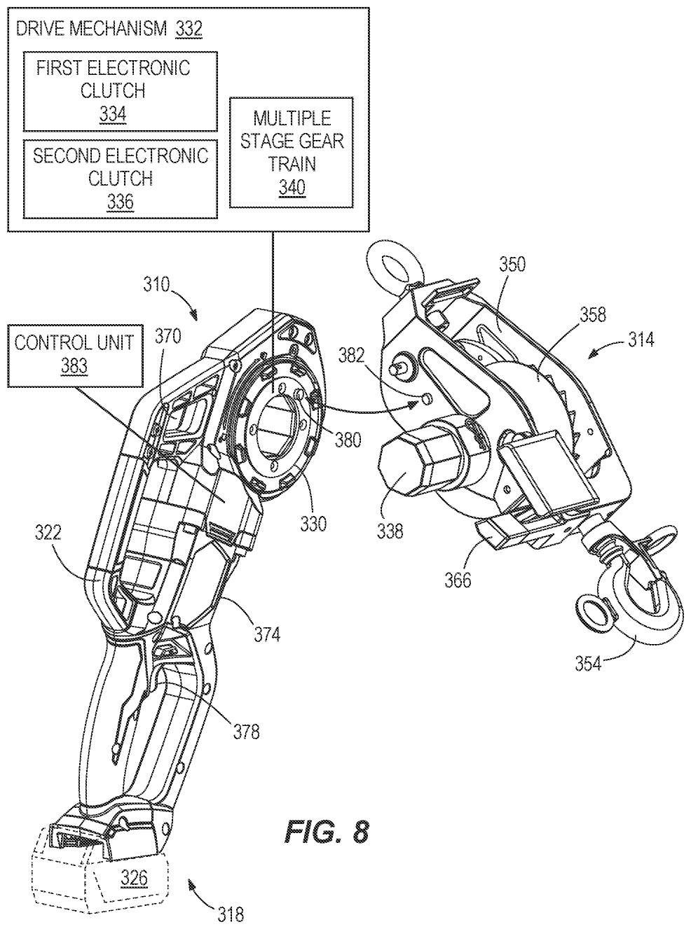

FIG. 8 illustrates a strap hoist assembly 310 according to another embodiment of the invention. The strap hoist assembly 310 is similar to the strap hoist assembly 10 described above, with like parts having the same reference number plus “300”, and the following differences explained below. The strap hoist assembly 310 includes a strap hoist 314 and a drive assembly 318 removably coupled to the strap hoist 314. The drive assembly 318 is operably coupled to the strap hoist 314 to selectively operate the strap hoist 314. The strap hoist 314 is further manually operable when disconnected from the drive assembly 318. In other words, the strap hoist 314 is both manually operated when disconnected from the drive assembly 318 or powered by the drive assembly 318. The strap hoist assembly 310 including the strap hoist 314 powered by the drive assembly 318 alleviates strain on the operator during the tensioning of high power electrical wires.

The drive assembly 318 includes a power unit 322, a battery pack 326 operably coupled to the power unit 322, and a coupler 330 that couples the power unit 322 to the strap hoist 314. In some embodiments, the power unit 322 can be a power tool (e.g., drill, an impact drill, a right-angle drill, or pipe threader) that is powered by the battery pack 326. In other embodiments, the power unit 122 can include an electric motor (e.g., a brushless DC electric motor) that is powered by the battery pack 326, such as an 18-volt battery pack 326.

In some embodiments, the drive assembly 318 includes a drive mechanism 332 configured to drive a reel 358 of the strap hoist 314. The drive mechanism 332 may include one or more electronic clutches 334, 336. As illustrated in FIG. 8, the drive assembly 318 may include a first electronic clutch 334 and a second electronic clutch 336 configured to drive the strap hoist 314.

In other embodiments, the drive mechanism 332 may include a gear train 340. The gear train 340 includes one or more stages, where each stage of the gear train 340 may be selectively activated to adjust the amount of torque input to the strap hoist 314. The gear train 340 can include a plurality of gears intermesh with one another to drive rotation of the reel 358 of the strap hoist 314. The gear train 340 is configured to adjust an output torque of the drive assembly 318 to prevent excessive torque from being applied to the strap hoist 314.

With continued reference to FIG. 8, the strap hoist 314 includes a frame 350, a hook 354 attached to the frame 350, a reel 358 disposed on the frame 350 for supporting a strap wrapped about the reel 358. The frame 350 includes an anti-rotation protrusion 366 that is received within a corresponding slot 370 formed in the drive assembly 318 (e.g., in a housing 374 of the power unit 22). The anti-rotation protrusion 366 restricts rotation of the strap hoist 314 relative to the drive assembly 318 when the power unit 322 is activated to provide torque to the strap hoist 314. When the drive assembly 318 is coupled to the strap hoist 314, the coupler 330 is operably coupled to the reel 358 via the adapter 338. The housing 374 of the power unit 322 includes a trigger or actuator 378 configured to be graspable and depressible by an operator of the drive assembly 318. Actuation of a trigger or actuator 378 causes the power unit 322 of the drive assembly 318 to rotate the coupler 330 and the reel 358 of the strap hoist 314 in a first rotational direction, which tightens the strap. The first rotational direction of the reel 358 may be changed to a second rotational direction (e.g., via a switch). The switch may be disposed on the housing 374 of the power unit 322. After pressing the switch, actuation of the trigger or actuator 78 causes the power unit 22 to rotate the coupler 330 and the reel 358 of the strap hoist 314 in the second rotational direction, which permits the effective length of the strap to be increased.

With reference to FIG. 8, the drive assembly 318 further includes a detent that supports a switch 380, and the strap hoist 314 further includes an external protrusion 382 that selectively engages the detent to actuate the switch 380. The external protrusion 382 is configured to align with the detent supporting the switch 380 to actuate the switch 380. Actuation of the switch 380 is configured to adjust an output torque from the drive assembly 318 to the reel 358 of the strap hoist 314. In some embodiments, where the drive mechanism 332 includes one or more electronic clutches 334, 336, the switch 380 may be a microswitch that provides an electrical input to an electronic control unit or control unit 383 of the drive assembly 318 (FIG. 8).

In other embodiments, where the drive mechanism 332 includes the gear train 340, the switch 380 may be a physical switch or mechanical switch that activates or deactivates one or more stages of the gear train 340. The detent and the external protrusion 382 are positioned such that, when the drive assembly 318 is coupled to the strap hoist 314 and an anti-rotation protrusion 366 is received by the slot 370 of the drive assembly 318, the external protrusion 382 engages the detent and actuates the switch 380.

When the switch 380 is actuated, the drive assembly 318 operates in a first mode with a first maximum output torque. When the switch 380 is not actuated, the drive assembly 318 operates in a second mode with a second maximum output torque. In some embodiments, the first maximum output torque may be greater than the second maximum output torque. In other embodiments, the first maximum output torque may be less than the second maximum output torque. The first maximum output torque and the second maximum output torque accommodate multiple strap hoists having varying force ratings.

The strap hoist assembly 310 further includes a second strap hoist (not shown). The strap hoist 314 can be a first strap hoist 314. The first strap hoist 314 includes a first rated force (e.g., 2 tons) having the external protrusion 382. The second strap hoist includes a second rated force (e.g., 1.5 tons) that is less than the first rated force and is devoid of the external protrusion 382. In such an embodiment, the drive assembly 318 is operated such that the second maximum output torque (e.g., when the switch 380 is not actuated) is less than the first maximum output torque. In other words, actuating the switch 380 increases the output torque of the drive assembly 318 to accommodate the higher rated force of the first strap hoist 314.

Alternatively, the first rated force (e.g., 1.5 tons) of the first strap hoist 314 may be less than the second rated force (e.g., 2 tons) of the second strap hoist. In such an embodiment, the drive assembly 318 is operated such that the second maximum output torque (e.g., when the switch 380 is not actuated) is greater than the first maximum output torque. In other words, actuating the switch 380 reduces the output torque of the drive assembly 318 to accommodate the lower rated force of the first strap hoist.

In other embodiments, the drive assembly 318 may include more than one detent and switch 380 (e.g., two, three, etc.), such that the power unit 322 can be operated in more than two modes with more than two different strap hoists. For example, each strap hoist may include an external protrusion 382 in a unique position or no external protrusion 382 (e.g., for a strap hoist that is rated for the torque output of the power unit). The power unit 322 may also include a corresponding detent and switch 380 for each strap hoist. In some embodiments, the drive assembly 318 may have two switches, such that it is operable with three different strap hoists with three different rated forces (e.g., 1 ton, 1.5 tons, 2 tons, etc.), depending on which switch, if either, is depressed.

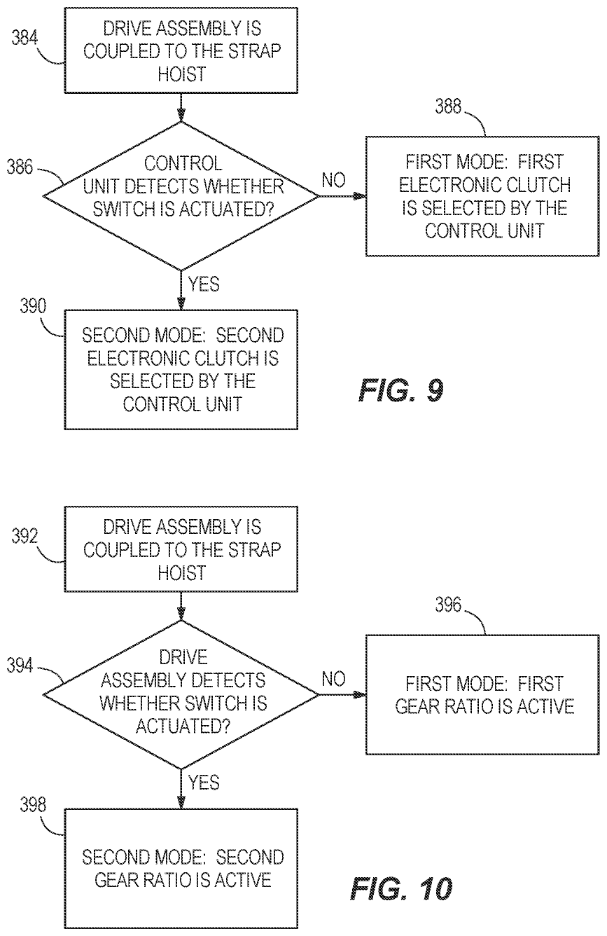

FIG. 9 illustrates a method of operation for the strap hoist assembly 310 when the drive mechanism 332 includes first and second electronic clutches 334, 336. The drive assembly 318 is coupled to a strap hoist (Step 384). The control unit 383 of the drive assembly 318 detects whether the switch 380 is actuated (Step 386). If the switch 380 is not actuated, the first electronic clutch 334 is selected by the control unit 383 (Step 388) to operate the drive assembly 318 in the first mode. When the first electronic clutch 334 is selected, the first electronic clutch 334 will deactivate the power unit 322 when a first current threshold is reached. The first current threshold is reached when the first maximum output torque is reached by the drive assembly 318.

If the switch 380 is actuated, the second electronic clutch 336 is selected (Step 390). When the second electronic clutch 336 is selected, the second electronic clutch 336 will deactivate the power unit 322 when a second current threshold is reached. The second current threshold is reached when the second maximum output torque is reached by the drive assembly 318. The drive assembly 318 may be restarted after being deactivated by cycling a trigger coupled of the drive assembly 318 between “off” and “on” states. Based on input from the switch 380, the control unit 383 selects one of the electronic clutches 334, 336 such that the maximum output torque of the drive assembly 318 causes the maximum output force of the strap hoist 314 to equal to the rated force of the strap hoist 314.

FIG. 10 illustrates a method of operation for the strap hoist assembly 310 when the drive mechanism 332 of the drive assembly 318 includes the gear train 340. The drive assembly 318 is coupled to the strap hoist 314 (Step 392). The drive assembly 318 detects whether the switch 380 is actuated (e.g., through mechanical engagement with the external protrusion 382) (Step 394). In some embodiments, the external protrusion 382 may directly engage the gear train 340, rather than the separate switch 380. When the switch 380 is actuated, the switch 380 actuates mechanical components inside the drive assembly 318 to selectively activate or deactivate a gear stage of the gear train 340 to alter the output torque provided to the strap hoist 314. For example, when the switch 380 is not actuated, the drive assembly 318 operates in the first mode with the gear train 340 operating at a first gear ratio (Step 396). When the switch 380 is actuated, the drive assembly 318 operates in the second mode with the gear train 340 operating at a second gear ratio (Step 398). The alteration of the output torque of the drive assembly 318 is such that the maximum output torque of the drive assembly 318 causes the maximum output force of the strap hoist 314 to equal to the rated force of the strap hoist 314. In some embodiments, the drive assembly 318 may include both a first switch (not shown) to change the gear ratio of the gear train 340 and a second switch (not shown) to activate the electronic clutches 334, 336. As such, for example, the maximum output torque of the drive assembly 318 and the rotational speed of the drive assembly 318 may be changed simultaneously.

In other embodiments, the drive assembly 318 or the strap hoist 314 may include alternative switches or mechanisms to adjust the operational mode or output torque of the power unit 322 as described above (e.g., via the electronic clutches 334, 336 or the multiple stage gear train 340) to accommodate strap hoists with different rated forces. In some embodiments, the control unit 383 of the power unit 322 may communicate with the strap hoist 314 over a short-range wireless technology protocol (e.g., BLUETOOTH or WiFi). For example, the strap hoist 314 may have a unique identification that corresponds to the rated force of the strap hoist 314. In such an embodiment, the communication between the power unit 322 and the strap hoist 314 may adjust the torque output. In other embodiments, the strap hoist 314 may include a unique radio frequency identification tag (RFID) that corresponds to the rated force of the strap hoist 314. In such an embodiment, communication between the control unit 383 of the power unit 322 and the RFID tag on the strap hoist 314 may adjust the torque output. In other embodiments, the strap hoist 314 may include a magnet and the switch 380 of the power unit 322 may detect the presence of the magnet. In such an embodiment, detection of the magnet may adjust the torque output of the power unit. Further, the switch 380 may be in communication with an indication system (e.g., LED lights) to display to operating mode to the user.

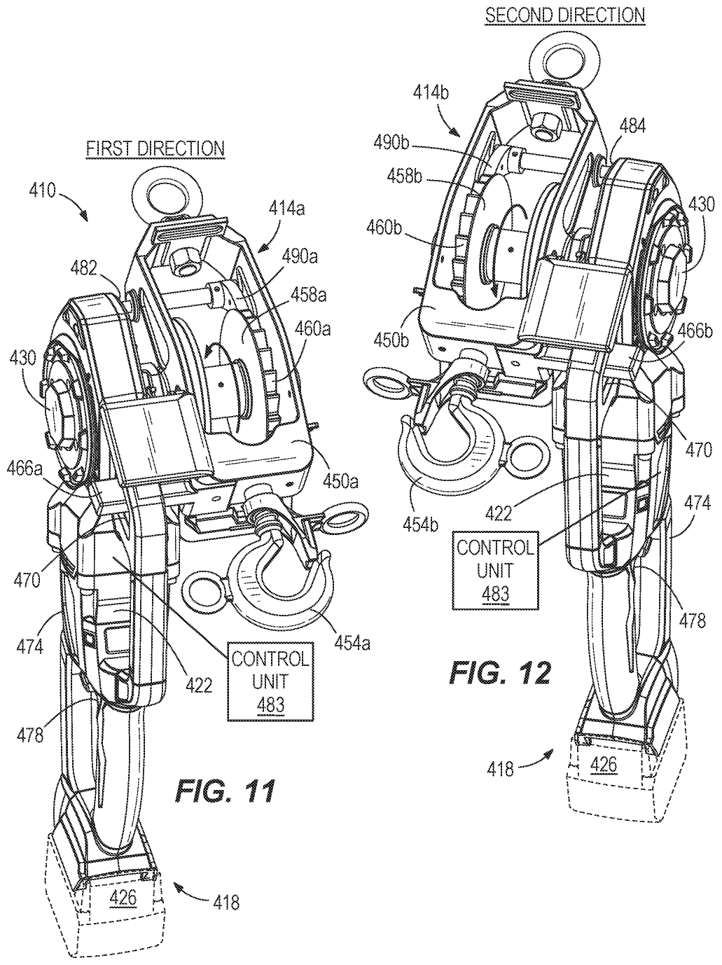

FIGS. 11 and 12 illustrate a strap hoist assembly 410 according to another embodiment of the invention. The strap hoist assembly 410 is similar to the strap hoist assembly 310 illustrated in FIG. 8 and described above, with like parts having the same reference number plus “400”, and the following differences explained below. The strap hoist assembly 410 includes a first strap hoist 414a, a second strap hoist 414b, and a drive assembly 418 removably coupled to one of the strap hoist 414a, 414b. The strap hoist 414a is similar to the strap hoist 414b, with like parts having the same reference numeral plus the letter “b”, and the following differences explained below. The drive assembly 418 is operably coupled to the strap hoist 414a, 414b to selectively operate the strap hoist 414a, 414b. The strap hoist 414a, 414b is further manually operable when disconnected from the drive assembly 318. In other words, the strap hoist 414a, 414b is both manually operated when disconnected from the drive assembly 318 or powered by the drive assembly 418. The strap hoist assembly 410 including the strap hoist 414 powered by the drive assembly 418 alleviates strain on the operator during the tensioning of high power electrical wires.

The drive assembly 418 includes a power unit 422, a battery pack 426 operably coupled to the power unit 422, and a coupler 430 that couples the power unit 422 to the strap hoist 414. In some embodiments, the power unit 422 may be a power tool (e.g., a drill, an impact drill, a right-angle drill, or a pipe threader) that is powered by the battery pack 426, such as an 18-volt battery pack 426. In other embodiments, the power unit 422 may be an electric motor such as a brushless direct current (DC) motor.

With reference to FIG. 11, the strap hoist 414a includes a frame 450a, a hook 454a attached to the frame 450a, and a reel 458a disposed on the frame 450a for supporting a strap wrapped thereon, and a lever or handle pivotably coupled to the frame 450a for manually rotating the reel 458a when the drive assembly 418 is disconnected from the strap hoist 414a. For example, the reel 458a includes a ratchet wheel 460a and a pawl 490a configured to engage or disengage with the ratchet wheel 460a. The frame 450a includes an anti-rotation protrusion 466a that is received within a corresponding slot 470 formed in the drive assembly 418 (i.e., in a housing 474 of the power unit 422). The housing 474 of the power unit 422 includes a trigger or actuator 478 configured to be graspable and depressible by an operator of the drive assembly 418. Actuation of the trigger or actuator 478 causes the power unit 422 to rotate the coupler 430 and the reel 458a of the strap hoist 414a in a rotational direction.

Similarly, with reference to FIG. 12, the strap hoist 414b includes a frame 450b, a hook 454b attached to the frame 450b, and a reel 458b disposed on the frame 450b for supporting a strap wrapped thereon, and a lever or handle pivotably coupled to the frame 450b for manually rotating the reel 458b when the drive assembly 418 is disconnected from the strap hoist 414b. For example, the reel 458b includes a ratchet wheel 460b and a pawl 490b configured to engage or disengage with the ratchet wheel 460b. The frame 450b includes an anti-rotation protrusion 466b that is received within the corresponding slot 470 formed in the drive assembly 418 (i.e., in the housing 474 of the power unit 422). The housing 474 of the power unit 422 includes a trigger or actuator 478 configured to be graspable and depressible by an operator of the drive assembly 418. Actuation of the trigger or actuator 478 causes the power unit 422 to rotate the coupler 430 and the reel 458b of the strap hoist 414b in a rotational direction.

With continued reference to FIGS. 11 and 12, the drive assembly 418 is operable in both a first rotational direction (e.g., clockwise) with a first maximum output torque, and a second rotational direction (e.g., counterclockwise) with a second maximum output torque. In some embodiments, the first rotational direction and the second rotational direction can be regulated by an electronic clutch. In other embodiments, the first output torque and the second output torque may be regulated by other mechanisms such as a mechanical clutch, or a gearbox with different gear ratios. The first strap hoist 414a is configured to couple to the drive assembly 418 in a first orientation (FIG. 11). The second strap hoist 414b is configured to couple to the drive assembly 418 in a second orientation (FIG. 12).

In the first orientation, the first strap hoist 414a is coupled to a first side 482 of the drive assembly 418. The drive assembly 418 includes an electronic control unit or control unit 483 that implements a first electronic clutch (not shown) in the first rotational direction (e.g., clockwise) when the strap hoist 414a is coupled to the drive assembly 418 in the first orientation. In the second orientation, the second strap hoist 414b is coupled to a second side 484 of the drive assembly 418. The control unit 483 implements a second electronic clutch (not shown) in the second rotational direction (e.g., counter clockwise) when the strap hoist 414b is coupled to the drive assembly 418 in the second orientation. Whereas, in the reverse rotational direction (e.g., counter-clockwise for the first strap hoist 414a and clockwise for the second strap hoist 414b), the first or second electronic clutch is bypassed because the tension in the strap is being released (i.e., opposite direction of clutch engagement).

The first strap hoist 414a includes a first rated force (e.g., 2 tons) and the second strap hoist 414b includes a second rated force (1.5 tons) that is less than the first rated force. The first strap hoist 414a includes a first alignment structure that allows it to be coupled with the drive assembly 418 in only the first orientation. When the first strap hoist 414a is coupled to the drive assembly 418, the electronic clutch limits output torque from the drive assembly 418 to the reel 458a of the strap hoist 414a such that an output force on the strap is equal to or less than the first force rating of the first strap hoist 414a. The second strap hoist 414b includes a second alignment structure that allows it to be coupled with the drive assembly 418 in only the second orientation. When the second strap hoist 414b is coupled to the drive assembly 418, the electronic clutch limits output torque from the drive assembly 418 to the reel 458b of the strap hoist 414b such that an output force on the strap is equal to or less than the second force rating of the second strap hoist 414b.

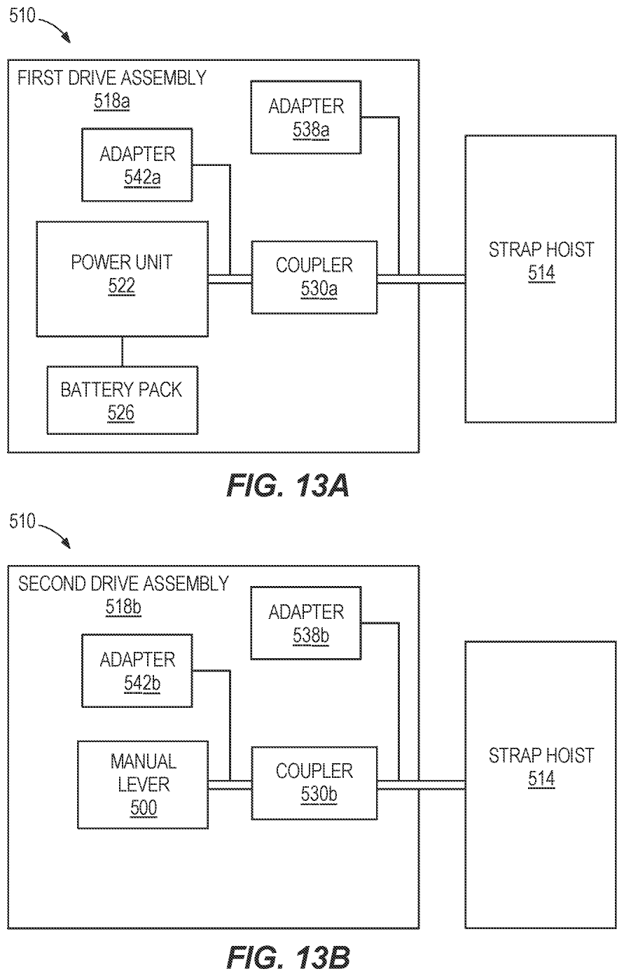

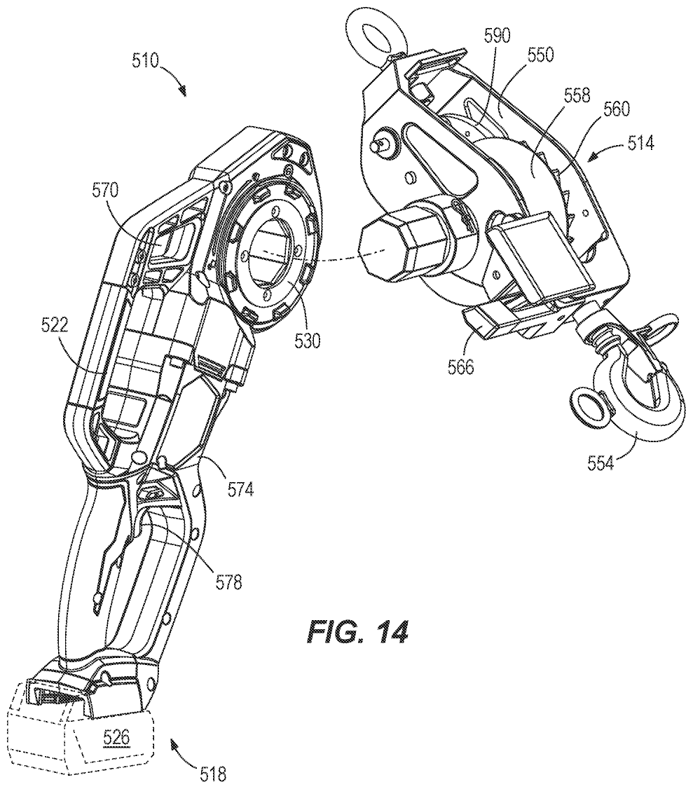

FIGS. 13A, 13B, and 14 illustrate a strap hoist assembly 510 according to another embodiment of the invention. The strap hoist assembly 510 is similar to the strap hoist assembly 10 described above, with like parts having the same reference number plus “500”, and the following differences explained below. The strap hoist assembly 510 includes a strap hoist 514, a first drive assembly 518a (FIGS. 13A and 14) removably coupled to the strap hoist 514, and a second drive assembly 518b (FIG. 13B) removably coupled to the strap hoist 514. The first drive assembly 518a is similar to the second drive assembly 518b, with like parts having the same reference numeral plus the letter “b”, and the following differences explained below. The drive assembly 518a is operably coupled to the strap hoist 514 to selectively operate the strap hoist 514 (FIG. 13A and 14). The strap hoist 514 is further manually operable when coupled to the drive assembly 518b (FIG. 13B).

With reference to FIGS. 13A and 14, the first drive assembly 518a further includes a power unit 522, a battery pack 526 operably coupled to the power unit 522, and a coupler 530a that couples the power unit 522 to the strap hoist 514. In some embodiments, the power unit 522 may include a drive mechanism (e.g., electronic clutch or gear train) that is powered by the battery pack 526, such as an 18-volt battery pack 526. The coupler 530a may include a quick-disconnect adapter 538a that allows the drive assembly 518a to be removed from the strap hoist 514. The adapter 538a engages a corresponding structure on the strap hoist 514 to secure the drive assembly 518a to the strap hoist 514. In some embodiments, a second adapter 542a may be positioned between the power unit 522 and the coupler 530a, which allows the power unit 522 to be removed from the coupler 530a.

With reference to FIG. 14, the strap hoist 514 includes a frame 550, a hook 554 attached to the frame 550, and a reel 558 disposed on the frame 550 for supporting a strap thereon, and a lever or handle pivotably coupled to the frame 550 for manually rotating the reel 558 when the drive assembly 518a is disconnected from the strap hoist 514. For example, the reel 558 includes a ratchet wheel 560 and a pawl 590 configured to engage or disengage with the ratchet wheel 560. The frame 550 includes an anti-rotation protrusion 566 that is received within a corresponding slot 570 formed in the drive assembly 518a (i.e., in a housing 574 of the power unit 522). The housing 574 of the power unit 522 includes a trigger or actuator 578 configured to be graspable and depressible by an operator of the drive assembly 518. Actuation of the trigger or actuator 578 causes the power unit 522 to rotate the coupler 530 and the reel 558 of the strap hoist 514 in a rotational direction.

With reference to FIG. 13B, the second drive assembly 518b includes a manual lever 500. The first drive assembly 518a can be detached from the strap hoist 514 and replaced with the second drive assembly 518b. The manual lever 500 couples with a coupler 530b to operate the strap hoist 514. In some embodiments, the coupler 530b can remain coupled to the strap hoist 514 during removal of the first drive assembly 518a. In other embodiments, the second drive assembly 518b can include a separate coupler 530b integrated with the manual lever 500. The coupler 530b includes the adapter 538b (e.g., quick disconnect) to allow for removal of the second drive assembly 518b from the strap hoist 514. Similarly, the adapter 538b engages the corresponding structure on the strap hoist 514 to secure the drive assembly 518b to the strap hoist 514. In some embodiments, a second adapter 542b may be positioned between the manual lever 500 and the coupler 530b, which allows the manual lever 500 to be removed from the coupler 530b.

For example, the first drive assembly 518a including the power unit 522 can be detached from the strap hoist 514 in situations where the battery pack 526 supplying electrical current to the power unit 522 is depleted or the power unit 522 fails. The second drive assembly 518b including the manual lever 500 is coupled to the strap hoist 514 to allow for continued operation of the strap hoist 514. The manual lever 500 is operable to rotate the reel 558 of the strap hoist 514 via application of a force applied by an operator to the manual lever 500. In other words, the strap hoist 514 is configured to be operated in response to movement of the manual lever 500 when the manual lever 500 is coupled to the strap hoist 514. The provided manual lever 500 is a sufficient length to provide sufficient mechanical advantage for a typical user to operate the strap hoist assembly 510 under normal operating conditions.

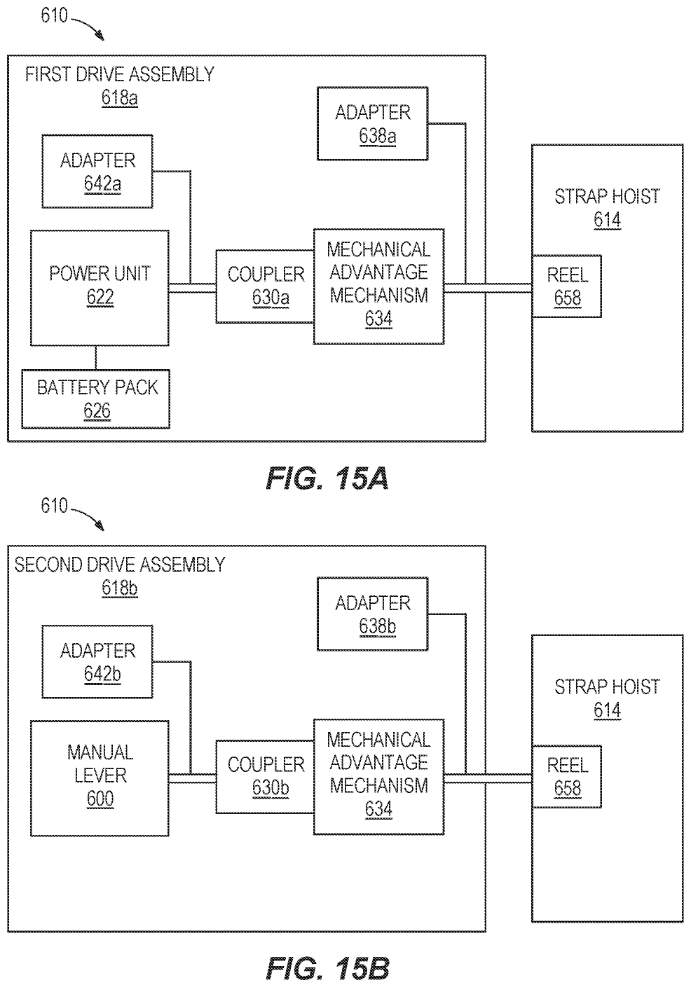

FIGS. 15A and 15B illustrate a strap hoist assembly 610 according to another embodiment of the invention. The strap hoist assembly 610 is similar to the strap hoist assembly 110 illustrated in FIG. 4 and described above, with like parts having the same reference number plus “600”, and the following differences explained below. The strap hoist assembly 610 includes a strap hoist 614, a first drive assembly 618a (FIG. 15A) removably coupled to the strap hoist 614, and a second drive assembly 618b (FIG. 15B) removably coupled to the strap hoist 614. The drive assembly 618a is operably coupled to the strap hoist 614 to selectively operate the strap hoist 614 (FIG. 15A). The strap hoist 614 is further manually operable when coupled to the drive assembly 618b (FIG. 15B).

With reference to FIG. 15A, the first drive assembly 618a includes a power unit 622, a battery pack 626 operably coupled to the power unit 622, a coupler 630a that couples the power unit 622 to the strap hoist 614. In some embodiments, the power unit 622 may include a drive mechanism (e.g., electronic clutch or gear train) that is powered by the battery pack 626, such as an 18-volt battery pack 626. The coupler 630a may include an adapter 638a (e.g., quick disconnect) that allows the first drive assembly 618a to be removed from the strap hoist 614. The adapter 638a engages a corresponding structure on the strap hoist 614 to secure the first drive assembly 618a to the strap hoist 614. In some embodiments, a second adapter 642a may be positioned between the power unit 622 and the coupler 630, which allows the power unit 622 to be removed from the coupler 630a.

With continued reference to FIG. 15A, the strap hoist assembly 610 further includes a mechanical advantage mechanism 634. The mechanical advantage mechanism 634 can be similar to the mechanical advantage mechanism 134, 134a as described above and shown in FIGS. 4 and 5. In the first drive assembly 618a, the mechanical advantage mechanism 634 can be positioned between the power unit 622 and the strap hoist 614. In the second drive assembly 618b, the mechanical advantage mechanism 634 can be positioned between the manual lever 600 and the strap hoist 614. In some embodiments, the mechanical advantage mechanism 634 can be integrated with the coupler 630a. In other embodiments, the mechanical advantage mechanism 634 can be integrated with the strap hoist 614. The mechanical advantage mechanism 634 can include one or more of a gear train, a cam, a ball screw, or a linkage system. The mechanical advantage mechanism 634 is operable to adjust the torque input to the strap hoist 614. The mechanical advantage mechanism 634 for example, can increase the torque input to the strap hoist 614, thereby not requiring the power unit 622 or operator to provide a large torque output.

With reference to FIG. 15B, the second drive assembly 618b includes a manual lever 600. The first drive assembly 618a can be detached from the strap hoist 614 and replaced with the second drive assembly 618b. The manual lever 600 couples with a coupler 630b to operate the strap hoist 614. In some embodiments, the mechanical advantage mechanism 634 can remain coupled to the strap hoist 614 during removal of the first drive assembly 618a. In other embodiments, the second drive assembly 618b can include a separate coupler 630b and the mechanical advantage mechanism 634 is integrated with the manual lever 600. The coupler 630b and/or mechanical advantage mechanism 634 includes an adapter 638b (e.g., quick disconnect) to allow for removal of the second drive assembly 618b from the strap hoist 614. The adapter 638b engages the corresponding structure on the strap hoist 614 to secure the drive assembly 618b to the strap hoist 614. In some embodiments, a second adapter 642b may be positioned between the manual lever 600 and the coupler 630b, which allows the manual lever 600 to be removed from the coupler 630b. The coupler 630b and/or the adapter 638b allows the second drive assembly 618b to be coupled to the strap hoist 614 when the first drive assembly 618a is removed.

For example, the first drive assembly 618a including the power unit 622 can be detached from the strap hoist 614 in situations where the battery pack 626 supplying electrical current to the power unit 622 is depleted or the power unit 622 fails. The second drive assembly 618b including the manual lever 600 is coupled to the strap hoist 614 to allow for continued operation of the strap hoist 614. The manual lever 600 is operable to rotate a reel 658 of the strap hoist 614 via application of a force applied by an operator to the manual lever 600. In other words, the strap hoist 614 is configured to be operated in response to movement of the manual lever 600 when the manual lever 600 is coupled to the strap hoist 614. The manual lever 600 includes a sufficient length to provide sufficient mechanical advantage for a typical user to operate the strap hoist assembly 610 under normal operating conditions.

Although the invention has been described in detail with reference to certain preferred embodiments, variations and modifications exist within the scope and spirit of one or more independent aspects of the invention as described.

Various features of the invention are set forth in the following claims.

1. A strap hoist assembly comprising:
a strap hoist including a frame and a reel for reeling a strap; and
a drive assembly removably coupled to the strap hoist, the drive assembly including a power unit and an onboard battery pack, the drive assembly configured to provide an output torque to rotate the reel in a rotational direction to apply an output force to the strap;
wherein the strap hoist is configured to be powered by the drive assembly or manually operated when disconnected from the drive assembly.

2. The strap hoist assembly of claim 1, wherein the strap hoist includes a hook attached to the frame, and wherein the strap hoist includes a handle attached to the frame for rotating the reel when the drive assembly is disconnected from the strap hoist.

3. The strap hoist assembly of claim 2, wherein the frame includes an anti-rotation protrusion, wherein the drive assembly includes a slot, and wherein the anti-rotation protrusion is received within the slot to restrict rotation of the strap hoist relative to the drive assembly.

4. The strap hoist assembly of claim 1, wherein the strap hoist includes a pawl and a ratchet wheel disposed on the reel, wherein the reel freely rotates in the rotational direction when the pawl is disengaged from the ratchet wheel, and wherein the reel does not rotate in the rotational direction when the pawl is engaged with the ratchet wheel.

5. The strap hoist assembly of claim 1, wherein the drive assembly includes a coupler configured to couple the power unit to the strap hoist.

6. The strap hoist assembly of claim 5, further comprising a first adapter positioned between the coupler and the strap hoist, and a second adapter positioned between the power unit and the coupler, wherein the first adapter is configured to remove the drive assembly from the strap hoist, and wherein the second adapter is configured to remove the coupler from the drive assembly.

7. A strap hoist assembly comprising:
a strap hoist including a frame and a reel for reeling a strap, the strap hoist having a force rating;
a drive assembly removably coupled to the strap hoist, the drive assembly configured to provide an output torque to rotate the reel in a rotational direction to apply an output force to the strap; and
a mechanical advantage mechanism configured to adjust the output torque applied to the reel such that the output force on the strap is equal to or less than the force rating of the strap hoist.

8. The strap hoist assembly of claim 7, wherein the mechanical advantage mechanism is selected from the group consisting of a gear train, a cam, a ball screw, and a linkage system.

9. The strap hoist assembly of claim 7, wherein the strap hoist includes a hook attached to the frame, and wherein the frame includes a handle for rotating the reel when the drive assembly is disconnected from the strap hoist.

10. The strap hoist assembly of claim 9, wherein the frame includes an anti-rotation protrusion, wherein the drive assembly includes a slot, and wherein the anti-rotation protrusion is received within the slot to restrict rotation of the strap hoist relative to the drive assembly.

11. The strap hoist assembly of claim 7, wherein the drive assembly includes a power unit and a coupler configured to couple the power unit to the strap hoist.

12. The strap hoist assembly of claim 11, wherein the power unit is powered by a battery pack.

13. The strap hoist assembly of claim 11, further comprising a first adapter positioned between the coupler and the strap hoist, and a second adapter positioned between the power unit and the coupler, wherein the first adapter is configured to remove the drive assembly from the strap hoist, and wherein the second adapter is configured to remove the coupler from the drive assembly.

14. The strap hoist assembly of claim 7, wherein the strap hoist is configured to be powered by the drive assembly or manually operated when disconnected from the drive assembly.

15. A strap hoist assembly comprising:
a first strap hoist including a first frame and a first reel for reeling a first strap, the first strap hoist having a first force rating;
a second strap hoist including a second frame and a second reel for reeling a second strap, the second strap hoist having a second force rating that is less than the first force rating; and
a drive assembly removably coupled to one of the first strap hoist or the second strap hoist, the drive assembly configured to provide an output torque to rotate the first reel or the second reel in a rotational direction to apply an output force to the first strap or the second strap, respectively;
wherein one of the first strap hoist or the second strap hoist is configured to be powered by the drive assembly or manually operated when disconnected from the drive assembly.

16. The strap hoist assembly of claim 15, further comprising a mechanical advantage mechanism configured to adjust the output torque applied to the first reel such that a first output force on the first strap is equal to or less than the first force rating, wherein the mechanical advantage mechanism is configured to adjust the output torque applied to the second reel such that a second output force on the second strap is equal to or less than the second force rating, and wherein the mechanical advantage mechanism is selected from the group consisting of a gear train, a cam, a ball screw, and a linkage system.

17. The strap hoist assembly of claim 15, wherein the first reel includes a first radius such that a first output force on the first strap hoist is equal to or less than the first force rating, and wherein the second reel includes a second radius such that a second output force on the second strap hoist is equal to or less than the second force rating, and wherein the second radius is greater than the first radius.

18. The strap hoist assembly of claim 15, wherein the drive assembly includes a power unit and a coupler configured to couple the power unit to one of the first strap hoist or the second strap hoist.

19. The strap hoist assembly of claim 18, wherein the power unit is powered by a battery pack.

20. The strap hoist assembly of claim 15, wherein the first frame includes a first anti-rotation protrusion, wherein the drive assembly includes a slot, wherein the first anti-rotation protrusion is receiveable within the slot to restrict rotation of the first strap hoist relative to the drive assembly, wherein the second frame includes a second anti-rotation protrusion, and wherein the second anti-rotation protrusion is alternately receiveable within the slot to restrict rotation of the second strap hoist relative to the drive assembly.

21-52. (canceled)
